(19) United States
(12) Patent Application Publication
(10) Pub. No.: US 2026/0371188 A1
(43) Pub. Date: Nov. 19, 2026

(54) TERMINAL, BASE STATION, RADIO COMMUNICATION SYSTEM AND RADIO COMMUNICATION METHOD

(71) Applicant: NTT DOCOMO, INC., Tokyo (JP)

(72) Inventor: Tianyang Min, Tokyo (JP)

(73) Assignee: NTT DOCOMO, INC., Tokyo (JP)

(21) Appl. No.: 19/488,459

(22) PCT Filed: Jul. 14, 2023
(86) PCT No.: PCT/JP2023/026124

§ 371 Date: Nov. 26, 2025

(51) Int. Cl. H04W 36/00

(52) U.S. Cl. CPC H04W 36/00725; H04W 36/0079

(57) ABSTRACT

A terminal includes a control unit that executes a specific handover without using a random access procedure in a lower layer than a radio resource control layer; and a transmission unit that transmits at least one of information relating to execution of the specific handover and a measurement report of the lower layer when executing the specific handover.

### TECHNICAL FIELD

The present disclosure relates to a terminal, a base station, a radio communication system and a radio communication method that support LTM (Lower layer Triggered Mobility).

### BACKGROUND ART

The 3rd Generation Partnership Project (3GPP) has prepared a specification for the 5th generation mobile communication system (which may be called 5G, New Radio (NR), or Next Generation (NG)), and is also in the process of specifying the next generation called Beyond 5G, 5G Evolution, or 6G.

In 3GPP Release 18, the enhancement of Layer 1/Layer 2 mobility (L1/L2 mobility) is discussed. L1/L2 mobility, which is also called lower layer triggered mobility (LTM), is a technology relating to mobility of a terminal (User Equipment, UE) in L1/L2, and for example, is a technology relating to handover (HO) of UE (Non-Patent Literature 1). HO in L1/L2 is controlled by a lower layer such as a medium access control (MAC) layer. In the following description, HO in L1/L2 is referred to as LTM in some cases for convenience.

### CITATION LIST

### Non-Patent Literature

Non-Patent Literature 1:“Further NR Mobility Enhancements”, RP-222332, 3GPP TSG RAN Meeting #97-e, 3GPP, Sep. 12-16, 2022

### SUMMARY OF INVENTION

Meanwhile, in 3GPP Release 18, RACH-less HO, which allows HO execution without requiring a random access procedure, is scheduled to be supported by LTM.

As a result of diligent study, when assuming that the RACH-less HO is supported by LTM, the inventors have found the necessity to clarify what kind of information should be reported to a network in response to a failure of the RACH-less HO.

The present disclosure has been made to solve the abovementioned problem, and has an object that is to provide a terminal, a base station, a radio communication system, and a radio communication method capable of appropriately constructing SON (Self Organizing Network) by reporting appropriate information in response to a failure of RACH-less HO in LTM.

An aspect of the disclosure is a terminal including: a control unit that executes a specific handover without using a random access procedure in a lower layer than a radio resource control layer; and a transmission unit that transmits at least one of information relating to execution of the specific handover and a measurement report of the lower layer when executing the specific handover.

An aspect of the disclosure is a base station including: a control unit that assumes that a terminal executes a specific handover without using a random access procedure in a lower layer than a radio resource control layer; and a reception unit that receives at least one of information relating to execution of the specific handover and a measurement report of the lower layer when the specific handover is executed.

An aspect of the disclosure is a radio communication system including: a terminal and a base station, in which the terminal includes: a control unit that executes a specific handover without using a random access procedure in a lower layer than a radio resource control layer; and a transmission unit that transmits at least one of information relating to execution of the specific handover and a measurement report of the lower layer when executing the specific handover.

An aspect of the disclosure is a radio communication method including: a step A of executing a specific handover without using a random access procedure in a lower layer than a radio resource control layer; and a step B of transmitting at least one of information relating to execution of the specific handover and a measurement report of the lower layer when executing the specific handover.

### BRIEF DESCRIPTION OF DRAWINGS

FIG. 1 is an overall schematic configuration diagram of a radio communication system 10.

FIG. 2 is a diagram illustrating frequency ranges used in the radio communication system 10.

FIG. 3 is a diagram illustrating a configuration example of a radio frame, a subframe, and a slot used in the radio communication system 10.

FIG. 4 is a functional block diagram of UE 200.

FIG. 5 is a functional block diagram of gNB 100.

FIG. 6 is a diagram for explaining an operation example.

FIG. 7 is a diagram for explaining an operation example.

FIG. 8 is a diagram for explaining an operation example.

FIG. 9 is a diagram illustrating an example of a hardware configuration of the gNB 100 and the UE 200.

FIG. 10 is a diagram illustrating a configuration example of vehicle 2001.

### DESCRIPTION OF EMBODIMENT

An embodiment will be described below based on the drawings. Note that the same or similar reference numerals have been attached to the same functions and configurations, and a description thereof will be omitted as appropriate.

### Embodiment

### (1) Overall Schematic Configuration of Radio Communication System

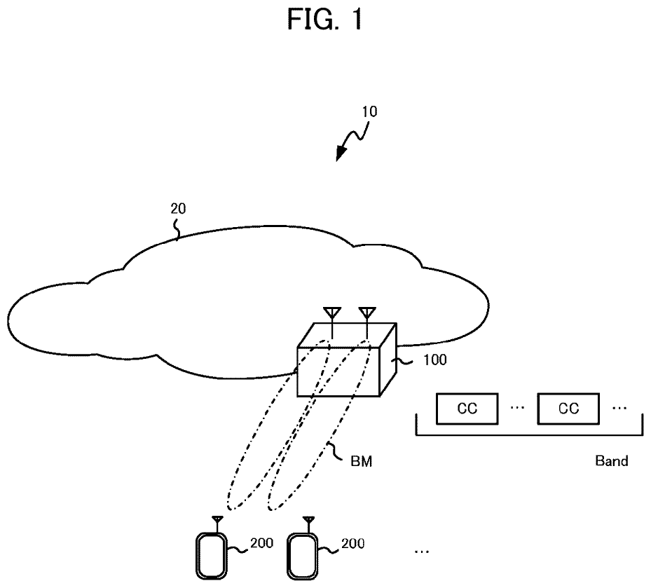

FIG. 1 is an overall schematic diagram of a radio communication system 10 according to the embodiment. The radio communication system 10 is a radio communication system according to 5G New Radio (NR), and includes a Next Generation-Radio Access Network 20 (hereinafter, it will be referred to as NG-RAN 20) and a terminal 200 (hereinafter, it will be referred to as UE (User Equipment) 200).

Note that the radio communication system 10 may be a radio communication system according to a scheme called Beyond 5G, 5G Evolution, or 6G.

The NG-RAN 20 includes a radio base station 100 (hereinafter, it will be referred to as gNB 100). Here, the specific configuration of the radio communication system 10 including the number of the gNBs 100 and the UEs 200 is not limited to the example illustrated in FIG. 1.

The NG-RAN 20 actually includes a plurality of NG-RAN nodes, specifically, gNBs (or ng-eNBs), and is connected to the core network according to 5G (5GC, not illustrated). Here, the NG-RAN 20 and 5GC may be simply referred to as a “network”.

The gNB 100 is a radio base station according to 5G, and performs a radio communication according to 5G with the UE 200. The gNB 100 and the UE 200 can support Massive MIMO (Multiple-Input Multiple-Output) that generates a beam BM with higher directivity by controlling radio signals transmitted from multiple antenna elements, carrier aggregation (CA) that uses multiple component carriers (CCs) bundled together, dual connectivity (DC) that simultaneously performs communication on two or more transport blocks between the UE and each of the two NG-RAN nodes, and the like.

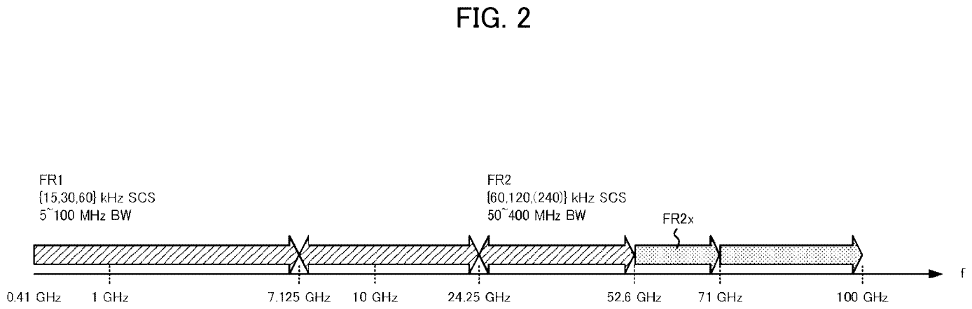

Further, the radio communication system 10 supports multiple frequency ranges (FRs). FIG. 2 is a diagram illustrating frequency ranges used in the radio communication system 10.

As illustrated in FIG. 2, the radio communication system 10 supports FR1, FR2-1, and FR2-2. The frequency bands of each FR are as follows.
FR1: 410 MHz to 7.125 GHz
FR2-1: 24.25 GHz to 52.6 GHz
FR2-2: 52.6 GHz to 71 GHz

In FR1, sub-carrier spacing (SCS) of 15, 30, or 60 kHz and a bandwidth (BW) of 5 to 100 MHz may be used. FR2-1 has a higher frequency than FR1, and SCS of 60 or 120 kHz (may include 240 kHz) and a bandwidth (BW) of 50 to 400 MHz may be used. FR2-2 has a higher frequency than FR2-1, and SCS of 120, 480, or 960 kHz and a bandwidth (BW) of 400 to 2000 MHz may be used.

The SCS may be interpreted as numerology. The numerology is defined in 3 GPP TS38.300 and corresponds to one subcarrier spacing in the frequency domain.

Further, the radio communication system 10 also supports a higher frequency band than that of FR2-2. Specifically, the radio communication system 10 supports a frequency band exceeding 52.6 GHz and up to 71 GHz or 114.25 GHz. Such a high frequency band may be called “FR 2x” for convenience.

In order to solve the problem that the effect of phase noise becomes large in a high frequency band, when a band exceeding 52.6 GHz is used, Cyclic Prefix-Orthogonal Frequency Division Multiplexing (CP-OFDM)/Discrete Fourier Transform-Spread (DFT-S-OFDM) having larger sub-carrier spacing (SCS) may be applied.

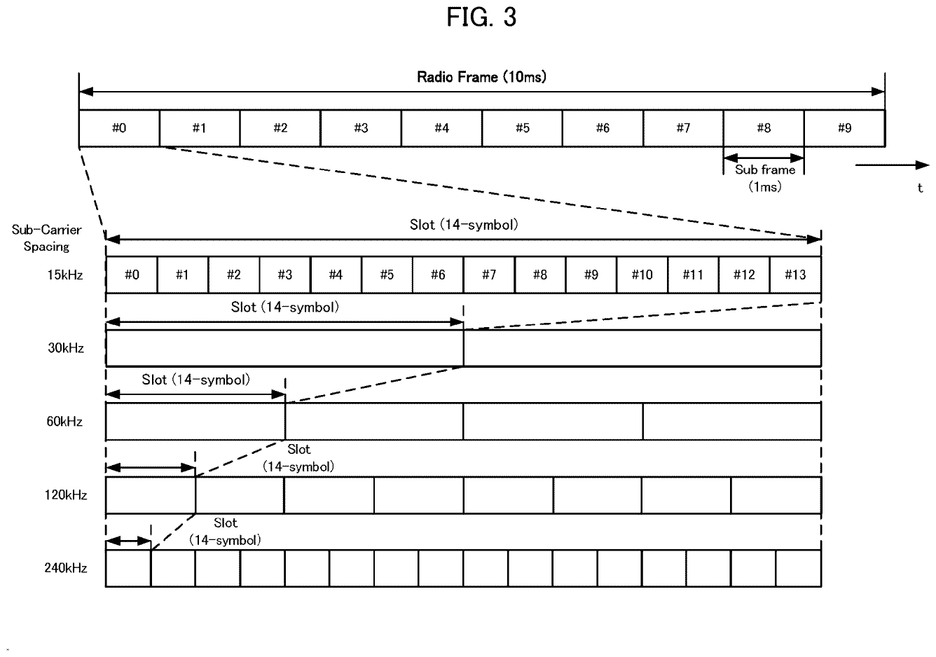

FIG. 3 illustrates a configuration example of a radio frame, a subframe, and a slot used in the radio communication system 10.

As illustrated in FIG. 3, one slot is constituted of 14 symbols, and, the symbol period (and slot period) becomes shorter as the SCS becomes larger (wider). The SCS is not limited to the spacing (frequency) illustrated in FIG. 3. For example, 480 kHz, 960 kHz, or the like may be used.

Note that the number of symbols constituting one slot may not necessarily be 14 symbols (for example, 28 or 56 symbols). Further, the number of slots for each subframe may vary depending on the SCS.

Note that the time direction (t) illustrated in FIG. 3 may be referred to as a time domain, a symbol period, symbol time, or the like. The frequency direction may be referred to as a frequency domain, a resource block, a sub-carrier, a bandwidth part (BWP), or the like.

A DMRS is a type of reference signal and is prepared for various channels. Here, unless otherwise specified, it may mean a DMRS for a downlink data channel, specifically, for a PDSCH (Physical Downlink Shared Channel). However, a DMRS for an uplink data channel, specifically, for a PUSCH (Physical Uplink Shared Channel), may be interpreted in the same way as a DMRS for a PDSCH.

The DMRS may be used in a device, for example, in the UE 200 for channel estimation as part of coherent demodulation. The DMRS may be present only in a resource block (RB) used for PDSCH transmission.

The DMRS may have multiple mapping types. Specifically, the DMRS has mapping type A and mapping type B. In mapping type A, a first DMRS is arranged on the second or third symbol of the slot. In mapping type A, the DMRS may be mapped based on the slot boundaries, regardless of where the actual data transmission starts in the slot. The reason why the first DMRS is arranged on the second or third symbol of the slot may be interpreted because the first DMRS is arranged after control resource sets (CORESET).

In mapping type B, a first DMRS may be arranged on the first symbol of the data allocation. That is, the position of the DMRS may be provided relative to where the data is arranged, not to the slot boundaries.

In addition, the DMRS may have multiple types. Specifically, the DMRS has Type 1 and Type 2. Type 1 and Type 2 differ in mapping in the frequency domain and in the maximum number of orthogonal reference signals. In Type 1, up to 4 orthogonal signals can be output with a single-symbol DMRS, and in Type 2, up to 8 orthogonal signals can be output with a double-symbol DMRS.

### (2) Functional Block Configuration of Radio Communication System

Next, a functional block configuration of the radio communication system 10 will be described.

First, a functional block configuration of the UE 200 will be described.

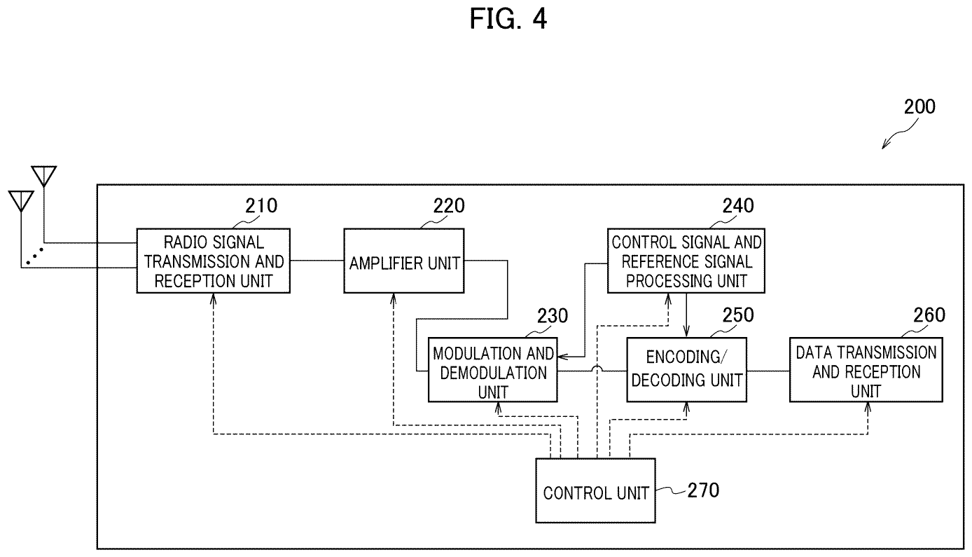

FIG. 4 is a functional block diagram of the UE 200. As illustrated in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives radio signals according to NR. The radio signal transmission and reception unit 210 supports Massive MIMO, carrier aggregation (CA) that uses a plurality of component carriers (CCs) bundled together, DC that simultaneously performs communication between the UE and each of two NG-RAN nodes, and the like.

The amplifier unit 220 includes a PA (Power Amplifier)/LNA (Low Noise Amplifier) and the like. The amplifier unit 220 amplifies a signal output from the modulation and demodulation unit 230 to a predetermined power level. The amplifier unit 220 also amplifies an RF signal output from the radio signal transmission and reception unit 210.

The modulation and demodulation unit 230 performs data modulation and demodulation, a transmission power configuration, a resource block allocation, and the like for each predetermined communication destination (gNB 100 or another gNB). Cyclic Prefix-Orthogonal Frequency Division Multiplexing (CP-OFDM)/Discrete Fourier Transform-Spread (DFT-S-OFDM) may be applied in the modulation and demodulation unit 230. In addition, DFT-S-OFDM may be used not only for an uplink (UL), but also for a downlink (DL).

The control signal and reference signal processing unit 240 performs processing regarding various control signals transmitted and received by the UE 200, and processing regarding various reference signals transmitted and received by the UE 200.

Specifically, the control signal and reference signal processing unit 240 receives various control signals transmitted from the gNB 100 via a predetermined control channel, for example, the control signals in the radio resource control layer (RRC). The control signal and reference signal processing unit 240 also transmits various control signals to the gNB 100 via a predetermined control channel.

The control signal and reference signal processing unit 240 performs processing using a reference signal (RS), such as a demodulation reference signal (DMRS) and a phase tracking reference signal (PTRS).

The DMRS is a terminal-specific reference signal (pilot signal) for estimating a fading channel used for data demodulation, known between a base station and the UE 200. The PTRS is a terminal-specific reference signal for the purpose of estimating phase noise which becomes a problem in a high frequency band.

The reference signals may include, in addition to the DMRS and PTRS, a channel state information-reference signal (CSI-RS), a sounding reference signal (SRS), and a positioning reference signal (PRS) for positional information.

The channels include control channels and data channels. The control channels may include a PDCCH (Physical Downlink Control Channel), a PUCCH (Physical Uplink Control Channel), a RACH (Random Access Channel), Downlink Control Information (DCI) including a Random Access Radio Network Temporary Identifier (RA-RNTI)), a Physical Broadcast Channel (PBCH), and the like.

In addition, the data channels may include a PDSCH (Physical Downlink Shared Channel), a PUSCH (Physical Uplink Shared Channel), and the like. The data refers to the data transmitted via the data channel. The data channels may be read as shared channels.

The control signal and reference signal processing unit 240 may receive downlink control information (DCI). The DCI includes, as existing fields, fields for storing DCI Formats, a Carrier indicator (CI), a BWP indicator, an FDRA (Frequency Domain Resource Assignment), a TDRA (Time Domain Resource Assignment), an MCS (Modulation and Coding Scheme), an HPN (HARQ Process Number), an NDI (New Data Indicator), an RV (Redundancy Version), and the like.

A value stored in the DCI Format field is an information element to specify a format of the DCI. A value stored in the CI field is an information element to specify a CC to which the DCI is applied. A value stored in the BWP indicator field is an information element to specify a BWP to which the DCI is applied. A BWP that can be specified by the BWP indicator is configured by an information element (BandwidthPart-Config) included in an RRC message. A value stored in the FDRA field is an information element to specify a frequency domain resource to which the DCI is applied. The frequency domain resource is specified by a value stored in the FDRA field and an information element (RA Type) included in an RRC message. A value stored in the TDRA field is an information element to specify a time domain resource to which the DCI is applied. The time domain resource is specified by a value stored in the TDRA field and an information element (pdsch-TimeDomainAllocationList, pusch-TimeDomainAllocationList) included in an RRC message. The time domain resource may be specified by a value stored in the TDRA field, and by a default table. A value stored in the MCS field is an information element to specify an MCS to which the DCI is applied. The MCS is specified by a value stored in the MCS, and by an MCS table. The MCS table may be specified by an RRC message, or specified by RNTI scrambling. A value stored in the HPN field is an information element to specify a HARQ process to which the DCI is applied. A value stored in the NDI is an information element to specify whether the data to which the DCI is applied is the initial transmission data. A value stored in the RV field is an information element to specify redundancy of data to which the DCI is applied.

The encoding/decoding unit 250 performs data division/concatenation, channel coding/decoding, and the like for each predetermined communication destination (gNB 100 or another gNB).

Specifically, the encoding/decoding unit 250 divides the data output from the data transmission and reception unit 260 into predetermined sizes, and performs channel coding on the divided data. The encoding/decoding unit 250 also decodes the data output from the modulation and demodulation unit 230, and concatenates the decoded data.

The data transmission and reception unit 260 transmits and receives a protocol data unit (PDU) and a service data unit (SDU). Specifically, the data transmission and reception unit 260 performs assembly/disassembly of PDU/SDU in a plurality of layers (a media access control layer (MAC), a radio link control layer (RLC), a packet data convergence protocol layer (PDCP) and the like). In addition, the data transmission and reception unit 260 performs error correction and retransmission control of data based on HARQ (Hybrid Automatic Repeat Request).

The control unit 270 controls each of functional blocks constituting the UE 200. In the embodiment, the control unit 270 includes a control unit that executes a specific handover without using a random access procedure in a lower layer (for example, L1/L2) than a radio resource control layer (for example, RRC). The HO in the L1/L2 may be referred to as LTM. The specific handover may be referred to as RACH-less based LTM.

The control unit 270 may instruct the radio signal transmission and reception unit 210 to transmit at least one of information relating to the execution of the RACH-less based LTM (hereinafter, it will be referred to as specific information) and a measurement report of a lower layer (for example, L1 measurement report) when executing the RACH-less based LTM. That is, in the embodiment, the radio signal transmission and reception unit 210 includes a transmission unit that transmits at least one of information relating to the execution of the specific handover and the measurement report of the lower layer when executing the specific handover. Note that the execution of the RACH-less based LTM may include a failure of the RACH-less based LTM or a success of the RACH-less based LTM.

The control unit 270 may execute a handover using the random access procedure in the lower layer when the execution of the RACH-less based LTM fails. The handover using the random access procedure in the lower layer may be referred to as RACH based LTM or fallback RACH based LTM.

The control unit 270 may specify a failure of the RACH-less based LTM before expiration of a timer (for example, T304) used to determine whether a handover (for example, LTM) has succeeded. The T304 may be a timer activated by receiving RRC Reconfiguration. In the LTM, the T304 may be activated by receiving a cell switch command received from the gNB 100. The control unit 270 may detect the expiration of the T304 and specify the failure of the handover when the elapsed time of the T304 reaches a predetermined time. The predetermined time may be referred to as an LTM supervisor time.

For example, the control unit 270 may specify the failure of the RACH-less based LTM when a specific time shorter than the predetermined time elapses after the activation of the T304. The specific time may be measured by the T304 or by a specific timer defined separately from the T304. For example, the specific timer may be a timer activated by the reception of the RRC Reconfiguration as in the case of the T304. In the LTM, the specific timer may be activated by the reception of the cell switch command received from the gNB 100 as in the case of the T304.

First, the specific information relating to the execution of the RACH-less based LTM may include the following information.

In option 1-1, the specific information may include information indicating that the execution of the RACH-less based LTM has failed. The specific information may include information indicating that the RACH-less based LTM has been executed along with information indicating the expiration of the T304. The specific information may include information relating to the RACH-less based LTM. The information relating to the RACH-less based LTM may include one or more pieces of information selected from the following: a cell ID of a source cell, a cell ID of a target cell, C-RNTI of a source cell, C-RNTI of a target cell, a TA value applied in the RACH-less based LTM, an indicator indicating whether a TA timer has expired, an indicator indicating whether a TA value is valid or invalid, elapsed time of the TA timer, and user plane (UP) interruption time.

In option 1-2, the specific information may include an indicator indicating whether the RACH based LTM has been executed after the RACH-less based LTM.

In option 1-3, when the execution of the RACH based LTM fails after the RACH-less based LTM, the specific information may include information indicating that the execution of the RACH based LTM has failed.

In option 1-4, when the RACH based LTM succeeds after the RACH-less based LTM, the specific information may include the information indicating that the RACH based LTM has succeeded.

In option 1-5, in a case where the RACH-less based LTM has succeeded, when the elapsed time of the T304 exceeds a time X, which is shorter than a predetermined time, the specific information may include information relating to the RACH-less based LTM. When the execution of the RACH based LTM is assumed after the RACH-less based LTM, the time X may be shorter than the specific time described above. The information relating to the RACH-less based LTM may include one or more pieces of information selected from the following: a cell ID of a source cell, a cell ID of a target cell, C-RNTI of a source cell, C-RNTI of a target cell, a TA value applied in the RACH-less based LTM, an indicator indicating whether a TA timer has expired, an indicator indicating whether a TA value is valid or invalid, elapsed time of the TA timer, and (user plane) UP interruption time.

In option 1-5, when the RACH based LTM is executed after the RACH-less based LTM, the specific information may include information indicating the timing when the RACH-less based LTM is switched to the RACH based LTM. For example, the information indicating the timing may be time from the start of RACH-less based LTM to the start of RACH based LTM. The information indicating the timing may be the elapsed time of the T304 at the timing when the RACH-less based LTM is switched to the RACH based LTM. The information indicating the timing may be the elapsed time of a specific timer at the timing when the RACH-less based LTM is switched to the RACH based LTM.

In option 1-6, the specific information may include information indicating the time required for LTM when the execution of the RACH based LTM is assumed after the RACH-less based LTM. The information indicating the time required for the LTM may be the time from the start of RACH-less based LTM to the completion of RACH based LTM. The information indicating the time required for the LTM may be the elapsed time of the T304 at the timing when the RACH based LTM is completed.

Note that two or more options selected from the option 1-1 to option 1-6 may be combined.

The UE 200 may transmit the specific information described in the option 1-1 to option 1-6 to the MN in dual connectivity. The specific information may be included in an SCG failure information message or a successful PSCell change report transmitted from the UE 200 to the MN.

Second, an L1 measurement report may include the following information. In the embodiment, the L1measurement report is a measurement report in a case where the RACH-less based LTM has failed. The L1 measurement report may be reported along with an L3 measurement report.

In option 2-1, the L1 measurement report may include an L1 measurement result (Cell ID, RSRP, SINR, etc.) of a serving cell.

In option 2-2, the L1 measurement report may include the L1 measurement result (Cell ID, RSRP, SINR, etc.) of a neighbor cell that exists in the neighborhood of the serving cell.

In option 2-3, the L1 measurement report may include the L1 measurement result (Cell ID, RSRP, SINR, etc.) of a candidate target cell for the RACH-less based LTM.

In option 2-4, the L1 measurement report may include the L1 measurement result (beam ID (SSB-index, CSI-RS index, TCI state index), RSRP, SINR, etc.) of a serving beam.

In option 2-5, the L1 measurement report may include the L1 measurement result (beam ID (SSB-index, CSI-RS index, TCI state index), RSRP, SINR, etc.) of a neighbor beam that exists in the neighborhood of the serving beam.

In option 2-6, the L1 measurement report may include the L1 measurement result (beam ID (SSB-index, CSI-RS index, TCI state index), RSRP, SINR, etc.) of a candidate target beam for the RACH-less based LTM.

Note that two or more options selected from the option 2-1 to option 2-6 may be combined.

The UE 200 may transmit the L1 measurement report described in the option 2-1 to option 2-6 to the MN in dual connectivity. The L1 measurement report may be included in the SCG failure information message or the successful PSCell change report transmitted from the UE 200 to the MN.

Second, a functional block configuration of the gNB 100 will be described.

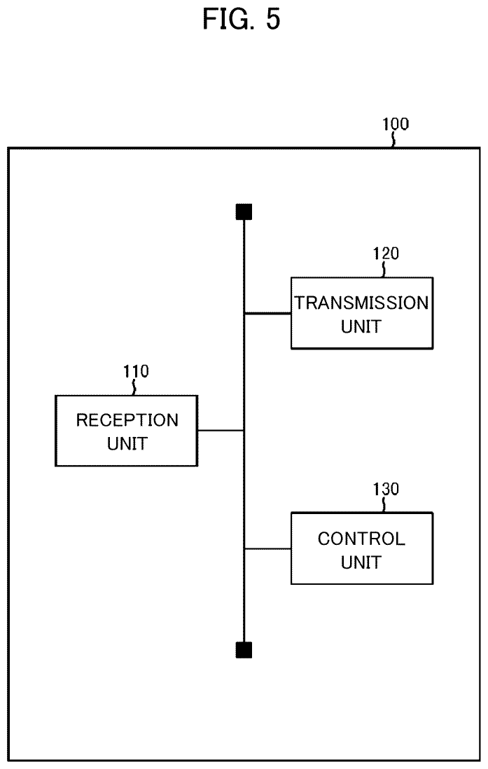

FIG. 5 is a functional block diagram of the gNB 100. As illustrated in FIG. 5, the gNB 100 includes a reception unit 110, a transmission unit 120, and a control unit 130.

The reception unit 110 receives various signals from the UE 200. The reception unit 110 may receive UL signals via PUCCH or PUSCH. In the embodiment, the reception unit 110 includes a reception unit that receives at least one of information relating to execution of a specific handover and a measurement report of a lower layer when the specific handover is executed.

The transmission unit 120 transmits various signals to the UE 200. The transmission unit 120 may transmit DL signals via PDCCH or PDSCH.

The control unit 130 controls the gNB 100. In the embodiment, the control unit 130 includes a control unit that assumes that a terminal (UE 200) executes the specific handover without using the random access procedure in the lower layer (for example, L1/L2) than the radio resource control layer (for example, RRC).

### (3) Problem

As a result of diligent study, when assuming the RACH-less based LTM described above, the inventors have found the necessity to clarify what kind of information should be reported to a network in response to a failure of the RACH-less based LTM.

To solve such a problem, the UE 200 transmits at least one of specific information relating to the execution of the RACH-less based LTM and the L1 measurement report when executing the RACH-less based LTM.

### (4) Operation Example

An operation example will be described below.

First, the RACH-less based LTM will be described.

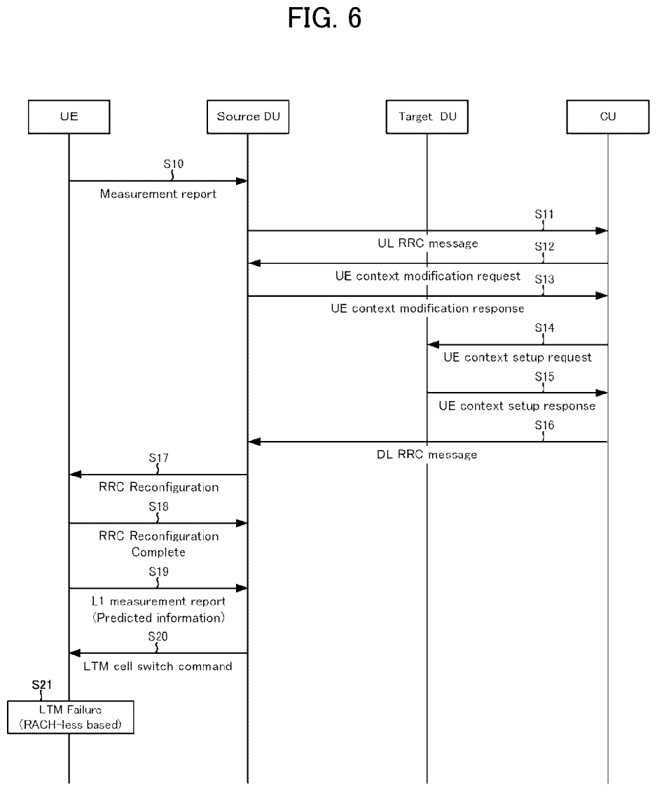

As illustrated in FIG. 6, in step S10, the UE 200 transmits a measurement report to the CU via the Source DU.

In step S11, the Source DU transmits a UL RRC message to the CU.

In step S12, the CU transmits a UE context modification request to the Source DU.

In step S13, the Source DU transmits a UE context modification response to the CU.

In step S14, the CU transmits a UE context setup request to the Target DU.

In step S15, the Target DU transmits a UE context setup response to the CU.

In step S16, the CU transmits a DL RRC message to the Source DU.

In step S17, the Source DU transmits RRCReconfiguration to the UE 200.

In step S18, the UE 200 transmits RRCReconfigurationComplete to the Source DU.

In step S19, the UE 200 transmits an L1 measurement report to the Source DU.

In step S20, the Source DU transmits an LTM cell switch command to the UE 200.

In step S21, the UE 200 specifies a failure of the RACH-less based LTM. The UE 200 may specify a failure of the RACH-less based LTM in response to expiration of the T₃₀₄ when the fallback RACH based LTM is not assumed. When the fallback RACH based LTM is assumed, the UE 200 may specify a failure of the RACH-less based LTM according to the lapse of a specific time.

Second, an operation of transmitting a failure information report in a case where the LTM has failed will be described. The failure information report may be referred to as a Radio Link Failure (RLF) Report.

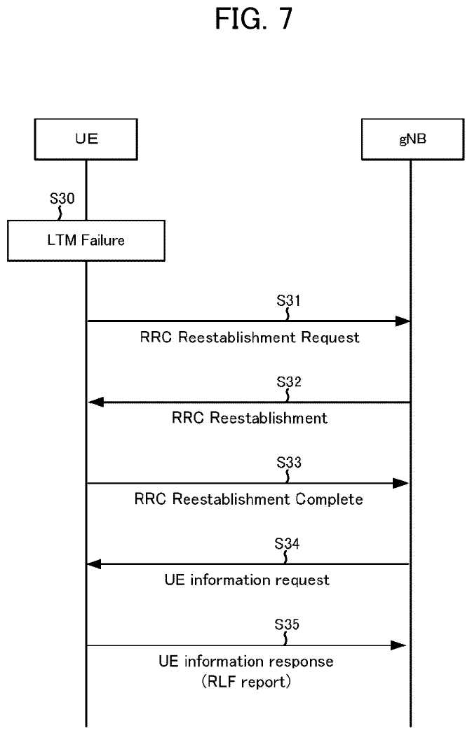

As illustrated in FIG. 7, in step S30, the UE 200 specifies a failure of the RACH-less based LTM. Step S30 may be considered similar to step S21 described above.

In step S31, the UE 200 transmits an RRC Reestablishment Request to the gNB 100.

In step S32, the gNB 100 transmits an RRC Reestablishment to the UE 200.

In step S33, the UE 200 transmits an RRC Reestablishment Complete to the gNB 100. The RRC Reestablishment Complete may include information (RLF-available) indicating that the UE 200 maintains information relating to the RACH-less based LTM. The RLF-available may be included in an RRC Reestablishment Request, an RRC Setup Complete, or an RRC Resume Complete instead of the RRC Reestablishment Complete.

In step S34, the gNB 100 transmits a UE information request to the UE 200.

In step S35, the UE 200 transmits a UE information response to the gNB 200. The UE information response may include an RLF report. The RLF may be considered to be included in an RRC message and may be considered to be an upper layer parameter.

Here, the RLF report may include the specific information (option 1-1 to option 1-6) relating to the execution of the RACH-less based LTM described above. The RLF report may include the L1 measurement report (option 2-1 to option 2-6) described above.

Third, an operation of transmitting a success information report in a case where the LTM has succeeded will be described. The success information report may be referred to as a Successful Handover Report (SHR).

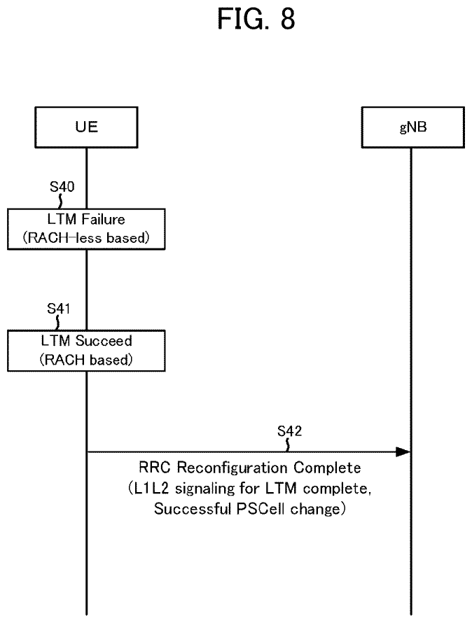

As illustrated in FIG. 8, in step S40, the UE 200 specifies a failure of the RACH-less based LTM. Step S40 may be considered similar to step S21 described above.

In step S41, the UE 200 specifies that the RACH-less based LTM has succeeded.

In step S42, the UE 200 transmits an RRC Reconfiguration Complete to the gNB 100. The RRC Reconfiguration Complete may include the SHR. The RRC Reconfiguration Complete may be read as L1L2 signaling for LTM complete and may be read as a successful PSCell change. The SHR may be considered to be included in an RRC message and may be considered to be an upper layer parameter.

Here, the SHR may include the specific information (option 1-1 to option 1-6) relating to the execution of the RACH-less based LTM described above. The SHR may include the L1 measurement report (option 2-1 to option 2-6) described above.

### (5) Operation and Effect

In the embodiment, when the RACH-less based LTM fails, the UE 200 transmits the specific information (option 1-1 to option 1-6) relating to the execution of the RACH-less based LTM. According to such a configuration, the information necessary for analysis, such as a cause of the failure or success of the RACH-less based LTM, is transmitted to the network side, and thus the SON (Self Organizing Network) can be appropriately constructed that assumes the RACH-less based LTM.

In the embodiment, when the RACH-less based LTM fails, the UE 200 transmits the L1 measurement report (option 2-1 to option 2-6). According to such a configuration, the information necessary for analysis, such as a cause of the failure or success of the RACH-less based LTM, is transmitted to the network side, and thus the SON can be appropriately constructed that assumes the RACH-less based LTM.

### (6) Modified Example

A modified example of the embodiment described above will be described below. In the following description, the differences from the embodiment will be mainly described.

The modified example focuses that in order for the UE 200 to transmit the RRC Reconfiguration (or L1L2 signaling for LTM complete) to the target cell in the RACH-less based LTM, the UL grant (dynamic grant, configured grant) needs to be set for the UE 200 in advance. If the UL grant is not set in the UE 200, the UE 200 cannot transmit the RRC Reconfiguration complete (or L1L2 signaling for LTM complete), and the RACH-less based LTM fails due to an expiration of a timer (for example, T304) used to determine whether a handover (for example, LTM) has succeeded or not (in other words, an elapse of LTM supervisor time). To solve this problem, the UE 200 may execute the following operations.

In option 3-1, when the UL grant is not set in the RACH-less based LTM and the RACH-less based LTM fails, the UE 200 may transmit the effect that the UL grant was not set as the specific information relating to the execution of the RACH-less based LTM.

In option 3-2, when the UL grant is not set in the RACH-less based LTM and the RACH-less based LTM fails, the UE 200 may transmit the effect that the RRC Reconfiguration complete (or L1L2 signaling for LTM complete) could not be transmitted as the specific information relating to the execution of the RACH-less based LTM.

### (7) Other Embodiments

The contents of the present invention have been described in accordance with the embodiment as above. However, it will be obvious to those skilled in the art that the present invention is not limited to these descriptions, and that various modifications and improvements are possible.

In the above disclosure, although the case has been mainly described in which the RACH-less based LTM has failed, the above disclosure is not limited to this. For example, the above disclosure may be applied to the case in which the RACH-less based LTM has succeeded.

Specifically, as described in the option 1-5, even in the case in which the RACH-less based LTM has succeeded, the UE 200 may transmit the specific information relating to the RACH-less based LTM when the elapsed time of the T304 exceeds a time X, which is shorter than a predetermined time.

Although not particularly limited, the option 1-1 to option 1-4 and option 1-6 are not applied to the case in which the RACH-less based LTM has succeeded, but may be applied to the case in which the RACH-less based LTM has failed.

Although the above disclosure has mainly described the RLF, the RLF may be read as HOF (Handover Failure).

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIG. 4 and FIG. 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but the functions are by no means limited to these. For example, a functional block (component) to implement a function of transmission may be referred to as a “transmitting section (transmitting unit),” a “transmitter”. The method for implementing each component is not particularly limited as described above.

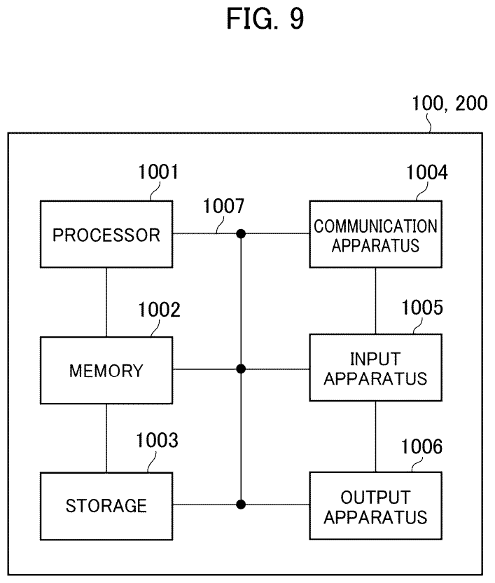

Furthermore, the above-described gNB 100 and UE 200 (the apparatus) may function as a computer that executes the processes of the radio communication method of the present disclosure. FIG. 9 is a diagram to show an example of a hardware structure of the apparatus. As shown in FIG. 9, the apparatus may each be formed as a computer apparatus that includes a processor 1001, a memory 1002, a storage 1003, a communication apparatus 1004, an input apparatus 1005, an output apparatus 1006, a bus 1007, and so on.

Note that in the following description, the word such as an apparatus can be read as a circuit, a device, a section, a unit, and so on. The hardware structure of the apparatus may be configured to include one or more of apparatuses shown in the drawings, or may be configured not to include part of apparatuses.

Each function block (see FIG. 4 and FIG. 5) of the apparatus is implemented by one of hardware elements or the combination of the hardware elements in the computer apparatus.

Each function of the apparatus is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The above-described various processes may be performed by a single processor 1001, or may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and so on. The memory 1002 may be referred to as a “register,” a “cache,” a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of a compact disc (Compact Disc ROM (CD-ROM) and so on), a hard disk drive, a flexible disk, a magneto-optical disk (for example, a compact disc, a digital versatile disc, a Blu-ray (registered trademark) disk), a smart card, a flash memory device (for example, a card, a stick, and a key drive), a floppy (registered trademark) disk, a magnetic stripe, and so on. The storage 1003 may be referred to as “auxiliary storage apparatus.” The above recording medium may be a database including at least one of the memory 1002 and the storage 1003, a server, or any other appropriate medium.

The Communication Apparatus 1004 Is Hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that performs output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, pieces of apparatus, including the processor 1001, the memory 1002, and others, are connected by a bus 1007 for communicating information. The bus 1007 may be formed with a single bus, or may be formed with buses that vary between pieces of apparatus.

Also, the apparatus may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information may be implemented by using physical layer signaling (for example, downlink control information (DCI), uplink control information (UCI)), higher layer signaling (for example, RRC signaling, Medium Access Control (MAC) signaling), broadcast information (master information block (MIB), system information block (SIB)), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New Radio (NR), New radio access (NX), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Specific operations which have been described in the present disclosure to be performed by a base station may, in some cases, be performed by an upper node thereof. In a network including one or a plurality of network nodes with the base station, it is clear that various operations that are performed to communicate with a terminal can be performed by the base station and other network nodes (for example, Mobility Management Entities (MMEs), Serving-Gateways (S-GWs), and so on may be possible, but these are not limiting) other than the base station, or combinations of these. According to the above, a case is described in which there is a single network node other than the base station. However, a combination of multiple other network nodes may be considered (e.g., MME and S-GW).

The information or signals may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A determination may be realized by a value (0 or 1) represented by one bit, by a boolean value (true or false), or by comparison of numerical values (e.g., comparison with a predetermined value).

Each aspect/embodiment described in the present disclosure may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

Software should be broadly interpreted to mean, regardless of whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies or wireless technologies is included within the definition of the transmission medium.

Information, a signal, or the like, described in the present disclosure may be represented by using any one of various different technologies. For example, data, an instruction, a command, information, a signal, a bit, a symbol, a chip, or the like, referred to throughout the above description, may be represented by a voltage, an electric current, electromagnetic waves, magnetic fields, a magnetic particle, optical fields, a photon, or a combination thereof.

It should be noted that a term described in the present disclosure and/or a term required for understanding of the present disclosure may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNodeB (eNB),” a “gNodeB (gNB),” an “access point,” a “transmission point,” a “reception point,” a “transmission/reception point,” a “cell,” a “sector,” a “cell group,” a “carrier,” a “component carrier,” and so on can be used interchangeably. A base station may be referred to as the terms such as a “macro cell,” a “small cell,” a “femto cell,” a “pico cell,” and so on.

A base station can accommodate one or a plurality of (for example, three) cells (which may be referred to as sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases by the skilled person in the art.

At least one of a base station and a mobile station may be referred to as a “transmitting apparatus,” a “receiving apparatus,” a “communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, a base station in the present disclosure may be interpreted as a mobile station (user terminal, hereinafter the same). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, the mobile station may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, a mobile station in the present disclosure may be interpreted as a base station. In this case, the base station may have the functions of the mobile station described above.

A radio frame may be constituted of one or a plurality of frames in the time domain. Each of one or a plurality of frames may be referred to as a “subframe” in the time domain.

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of the number of symbols less than a slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may be a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of one or more wires, cables, and printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot”, depending on which standard is applied.

The phrase “based on” as used in the present disclosure does not mean “based only on”, unless otherwise specified. In other words, the phrase “based on” means both “based only on” and “based at least on”.

“Means” included in the configuration of each of the above apparatuses may be replaced by “parts”, “circuits”, “devices”, etc.

Reference to elements with designations such as “first,” “second,” and so on used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present disclosure is not intended to be an “exclusive or”.

In the present disclosure, in the case where an article is added by translation, for example “a”, “an”, and “the”, the disclosure may include that the noun following these articles is plural.

As used in the present disclosure, the term “determining” may encompasses a wide variety of actions. For example, “determining” may be regarded as determining to have performed judging, calculating, computing, processing, deriving, investigating, looking up (looking up, search, inquiry) (e.g., looking up in a table, a database or another data structure), ascertaining and the like. Also, “determining” may be regarded as determining to have performed receiving (e.g., receiving information), transmitting (e.g., transmitting information), inputting, outputting, accessing (e.g., accessing data in a memory) and the like. Also, “determining” may be regarded as determining to have performed resolving, selecting, choosing, establishing, comparing and the like. That is, “determining” may be regarded as determining to have performed some action. Moreover, “determining” may be read as “assuming”, “expecting”, “considering”, and the like.

In this disclosure, the term “A and B are different” may mean “A and B are different from each other.” It should be noted that the term “A and B are different” may mean “A and B are different from C.” Terms such as “separated” or “combined” may be interpreted in the same way as the “different”.

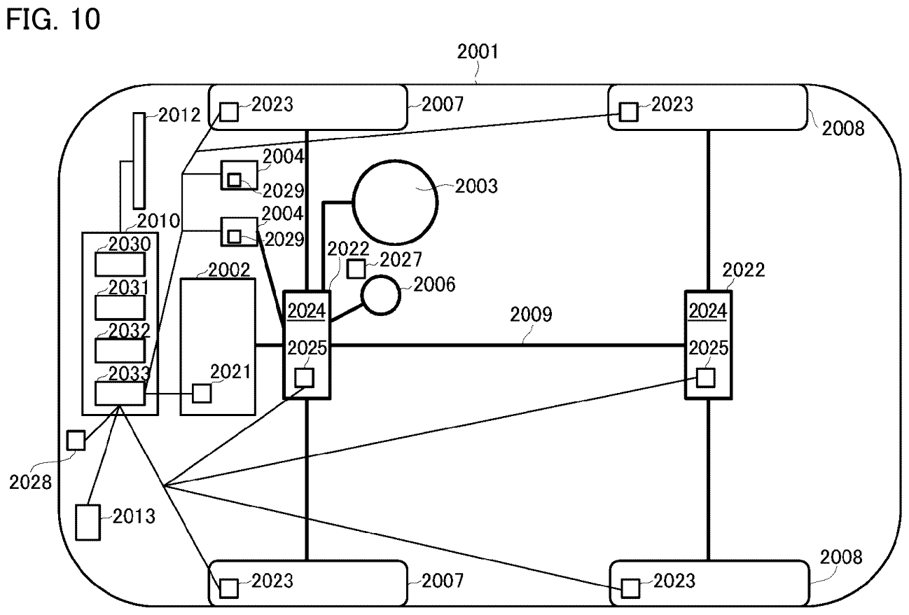

FIG. 10 shows an example of a configuration of a vehicle 2001. As shown in FIG. 10, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021-2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-29 provided in the vehicle. The electronic control unit 2010 may be referred to as an ECU (Electronic Control Unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and the sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal from a current sensor, which is input to the electronic control unit 2010, to external devices through radio communication. Also, the communication module 2013 transmits to external devices through radio communication, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, an accelerator pedal stepped-on amount signal acquired by an accelerator pedal sensor 2029, a brake pedal stepped-on amount signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like, which are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

As described above, the present disclosure has been described in detail. It is apparent to a person skilled in the art that the present disclosure is not limited to one or more embodiments described in the present disclosure. The present disclosure can be implemented as modifications and variations without departing from the subject matter and the scope of the present disclosure defined by the descriptions of claims. Therefore, the descriptions of the present disclosure are for illustrative purposes only, and are not intended to be any limitations to the present disclosure.

### Supplementary Notes

The above disclosure may be expressed as follows.

A first feature is a terminal including: a control unit that executes a specific handover without using a random access procedure in a lower layer than a radio resource control layer; and a transmission unit that transmits at least one of information relating to execution of the specific handover and a measurement report of the lower layer when executing the specific handover.

A second feature is the terminal according to the first feature, in which the control unit executes a handover using the random access procedure in the lower layer when the execution of the specific handover fails.

A third feature is the terminal according to the first feature or second feature, in which the control unit specifies a failure of the specific handover before expiration of a timer used to determine whether a handover has succeeded.

A fourth feature is a base station including: a control unit that assumes that a terminal executes a specific handover without using a random access procedure in a lower layer than a radio resource control layer; and a reception unit that receives at least one of information relating to execution of the specific handover and a measurement report of the lower layer when the specific handover is executed.

A fifth feature is a radio communication system including a terminal and a base station, in which the terminal includes: a control unit that executes a specific handover without using a random access procedure in a lower layer than a radio resource control layer; and a transmission unit that transmits at least one of information relating to execution of the specific handover and a measurement report of the lower layer when executing the specific handover.

A sixth feature is a radio communication method including: a step A of executing a specific handover without using a random access procedure in a lower layer than a radio resource control layer; and a step B of transmitting at least one of information relating to execution of the specific handover and a measurement report of the lower layer when executing the specific handover.

### REFERENCE SIGNS LIST

10 radio communication system
20 NG-RAN
100 gNB
110 reception unit
120 transmission unit
130 control unit
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 right and left front wheels
2008 right and left rear wheels
2009 axle
2010 electronic control unit
2012 information service unit
2013 communication module
2021 current sensor
2022 rotational speed sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A terminal comprising:
a control unit that executes a specific handover without using a random access procedure in a lower layer than a radio resource control layer; and
a transmission unit that transmits at least one of information relating to execution of the specific handover and a measurement report of the lower layer when executing the specific handover.

2. The terminal according to claim 1, wherein
the control unit executes a handover using the random access procedure in the lower layer when the execution of the specific handover fails.

3. The terminal according to claim 1, wherein
the control unit specifies a failure of the specific handover before expiration of a timer used to determine whether a handover has succeeded.

4. A base station comprising:
a control unit that assumes that a terminal executes a specific handover without using a random access procedure in a lower layer than a radio resource control layer; and
a reception unit that receives at least one of information relating to execution of the specific handover and a measurement report of the lower layer when the specific handover is executed.

5. A radio communication system including: a terminal and a base station, wherein the terminal comprises:
a control unit that executes a specific handover without using a random access procedure in a lower layer than a radio resource control layer; and
a transmission unit that transmits at least one of information relating to execution of the specific handover and a measurement report of the lower layer when executing the specific handover.

6. A radio communication method comprising:
a step A of executing a specific handover without using a random access procedure in a lower layer than a radio resource control layer; and
a step B of transmitting at least one of information relating to execution of the specific handover and a measurement report of the lower layer when executing the specific handover.
